(19) United States
(12) Patent Application Publication
(10) Pub. No.: US 2005/0132352 A1
(43) Pub. Date: Jun. 16, 2005

(54) Installation of hardware devices

(75) Inventor: James Zhongming Shen, Sunnyvale, CA (US)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc.

(21) Appl. No.: 10/732,244

(22) Filed: Dec. 11, 2003

(51) Int. Cl. G06F 9/445

(52) U.S. Cl. 717/174

(57) ABSTRACT

Systems and methods for installation of hardware devices are provided. Hardware devices can include a mass storage medium which stores device drivers for one or more operating systems. The device driver stored on the mass storage medium can used for installing the hardware device. When a hardware device is connected to a computer, and it is determined that the software device driver for the particular device has not been installed by the operating system, the operating system can use a device driver stored on the mass storage medium.

### BACKGROUND

The present invention is directed to systems and methods for installing a hardware device on a computer. Specifically, the present invention is directed to the installation of a software driver for allowing use of a hardware device connected to a computer.

For many computer users installation of hardware devices can be quite challenging. In the past, installation of a new hardware device could require setting interrupt requests (IRQs), setting jumpers and/or setting DIP switches. To address these problems, plug and play installation has been introduced into many operating systems. Plug and play eliminates the need for setting interrupt requests, jumpers and DIP switches.

Although the use of plug and play has reduced some of the difficulty in installing hardware devices, it is still necessary to install software device drivers. A software device driver provides instructions for reformatting or interpreting software commands for transferring information between hardware devices and a computer's central processing unit (CPU). The installation of a new hardware device may require the computer user to begin an installation process by notifying an operating system that a new hardware device has been installed. In some operating systems the installation of the hardware device may be automatically recognized. Regardless of whether the computer user must notify the operating system of the installation of a new hardware device or whether the operating system automatically recognizes such an installation, an installation process is initiated by the operating system.

Part of the installation process requires the installation of a software driver for the particular piece of hardware. Some hardware devices are designed so that they can be used with generic drivers. Recognizing that the hardware device can operate using the generic device driver, the operating system may automatically install the generic device driver or provide the user an option to install the generic device driver. However, the use of generic device drivers is typically limited to devices such as keyboards, mice and hard drives.

To provide an increased amount of functionality for a hardware device, device specific drivers are required. These device drivers are specific not only to the particular type of hardware device, for example a printer, but also for the particular model of the device. To increase ease of installation, many hardware manufacturers will provide device drivers to operating system manufacturers who will incorporate the device drivers into the operating system. When such a hardware device is installed, the operating system may look to a specific operating system folder for the device driver, or may prompt the computer user to insert the operating system installation disk. However, new hardware devices are being introduced constantly, while operating systems are typically produced every few years. Accordingly, an operating system will typically have only a limited subset of device drivers, limited to those in existence at the time the operating system was produced.

For hardware devices whose device drivers are not part of an operating system, during the installation process the operating system may prompt the user for the location of the device driver. This can be a confusing process since many times a device driver has an esoteric name and is located in a subfolder in a directory on a removable storage medium, such as a floppy or CD ROM disk. Specifically, each different operating system requires a different device driver. Accordingly, the media containing the device drivers will typically contain a folder for each different operating system. The user will be required to navigate the directory structure of the media containing the device drivers in order to identify the location of the device driver to the operating system. Additionally, many hardware manufacturers include a large number of device drivers on the media containing the device driver for the specific hardware device. Accordingly, a computer user will have to select between a number of device drivers, all of which are compatible with the particular operating system.

All of the problems described above can be time consuming and create frustration for a computer user. Accordingly, it would be desirable to provide systems and methods which make the installation of new hardware devices easier for a computer user.

### SUMMARY

In accordance with exemplary embodiments of the present invention, hardware devices are provided with a mass storage medium. The mass storage medium can contain device drivers for a specific operating system, or device drivers for a number of operating systems. Accordingly, when a hardware device is connected to a computer, the operating system can automatically identify the device driver for the particular operating system stored in the mass storage medium. Alternatively, the operating system, during installation of the hardware device, can provide the user with a number of options of where the operating system can locate the device driver, including an option to install the device driver from the mass storage medium of the hardware device.

### BRIEF DESCRIPTION OF THE DRAWING FIGURES

The objects and advantages of the invention will be understood by reading the following detailed description in conjunction with the drawings in which:

FIG. 1 illustrates an exemplary hardware device in accordance with the present invention;

FIG. 2 illustrates an exemplary method for installation of a hardware device in accordance with the present invention; and

FIG. 3 illustrates an exemplary method for retrieving drivers in accordance with the present invention.

### DETAILED DESCRIPTION

The various features of the invention will now be described with reference to the figures, in which like parts are identified with the same reference characters.

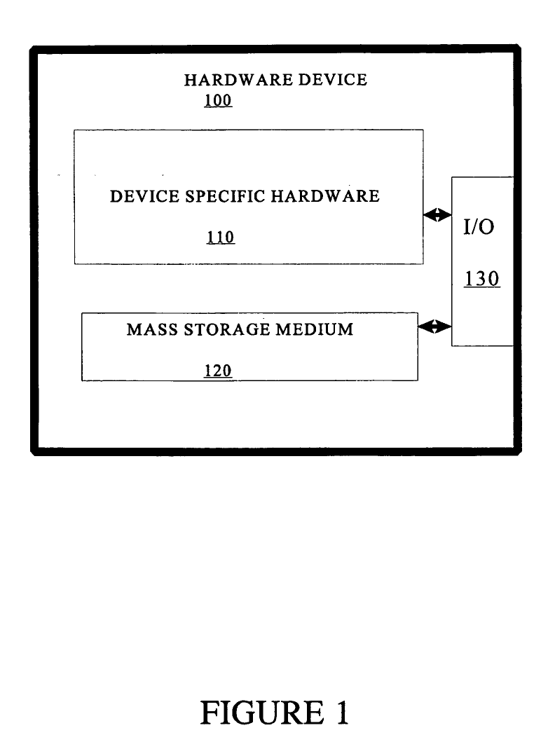

FIG. 1 illustrates an exemplary hardware device 100 in accordance with the present invention. The hardware device 100 can be a peripheral device which is external to the computer, such as a printer, scanner, digital camera, MP3 player, and the like. Additionally, the hardware device 100 can be an internal hardware device, such as a video card, internal modem, network interface card, port expansion card, and the like. The hardware device 100 includes device specific hardware 110, mass storage medium 120, and an input/output (I/O) 130 interface. The device specific hardware 110 will depend upon the particular hardware device. The I/O interface 130 can be a conventional parallel port interface, USB (1.0 or 2.0) port interface, Firewire port interface, PCI interface, PCMCIA interface, and the like. Mass storage medium 120 contains device drivers for one or more operating systems. Mass storage medium 120 can be a flash memory, a disk drive, such as a hard disk drive, and the like.

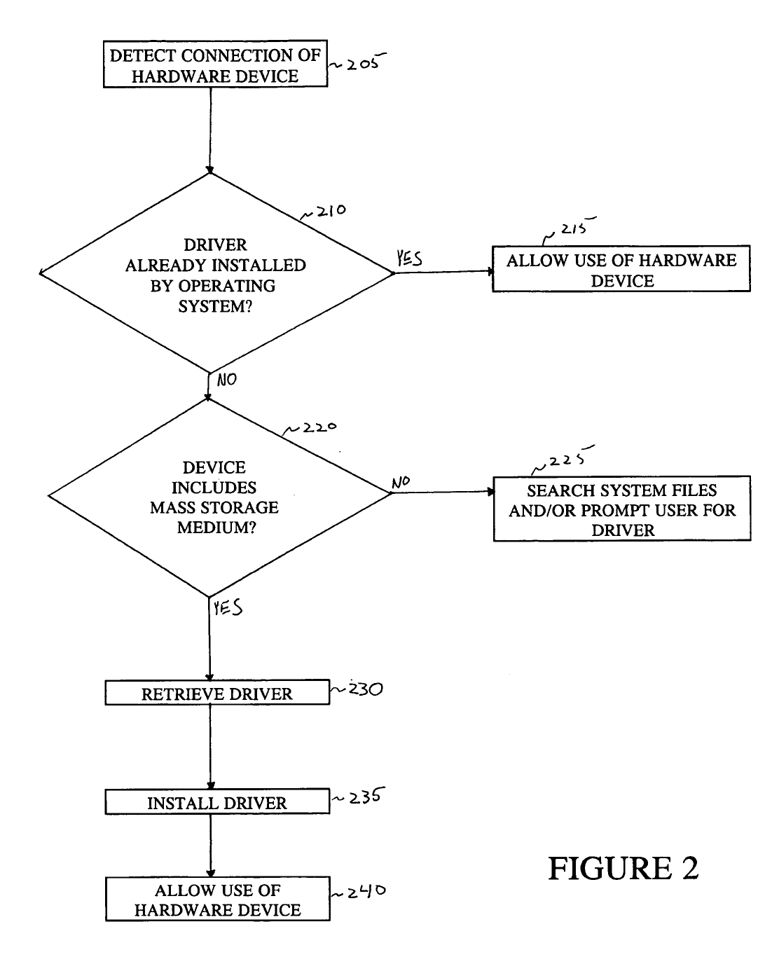

FIG. 2 illustrates an exemplary method for installation of a hardware device in accordance with the present invention. When the operating system detects connection of a hardware device (step 205), it determines whether a driver for the hardware device has already been installed by the operating system (step 210). The operating system can automatically detect the connection of the hardware device, or can detect the connection of the hardware device based upon a process initiated by the user, e.g., a system program which scans the ports of a computer to detect connected hardware devices. If the operating system determines that a driver for the hardware device has already been installed by the operating system (“YES” path of decision step 210), then the user is allowed to use the hardware device (step 215).

If the operating system determines that a driver for the hardware device has not been installed by the operating system (“NO” path of decision step 210), then it determines whether the device includes a mass storage medium (step 220). If the operating system determines that the hardware device does not include a mass storage medium (“NO” path of decision step 220), then the operating system will search system files and/or prompt the user for the device driver (step 225).

If, however, the operating system determines that the device includes a mass storage medium (“YES” path of decision step 220), then the operating system will retrieve the device driver (step 230), install the device driver (step 235), and allow use of the hardware device (step 240). As discussed above, the device driver can either be automatically installed by the operating system, or the user can be prompted with an option to install the device driver from the mass storage medium of the hardware device.

The order of the steps described above is not critical to the operation of the present invention. For example, the operating system may detect the presence of a mass storage medium in the hardware device prior to the determination of whether a driver for the device has been installed by the operating system. Moreover, the method may include additional steps depending upon the particular operating system used. For example, the operating system can determine whether the device driver on the mass storage medium is digitally signed, and if not, notify the user that the installation of device drivers which are not digitally signed may result in instability of the operating system.

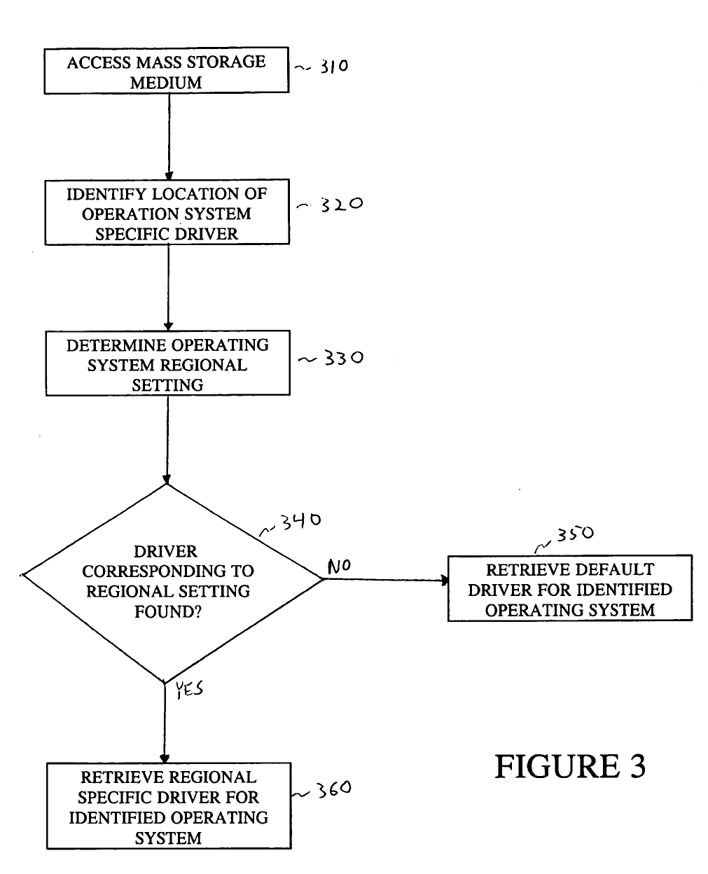

FIG. 3 illustrates an exemplary method for retrieving a device driver from a mass storage medium in accordance with the present invention. Accordingly, the method of FIG. 3 would occur in step 230 of FIG. 2. The retrieval process begins by accessing the mass storage medium (step 310) and identifying the location of a device driver for the particular operating system (step 320). The mass storage medium can have separate paths (folders) for each operating system or all of the device drivers can be in the root folder. The folders and device drivers can be named in such a way as to be easily identifiable by the operating system, for example “Linux” for a Linux device driver. Alternatively, an operating system can include a predetermined naming system to assist in the identifying device drivers, e.g., a Linux operating system can be designed to look for a folder and/or a device driver with a name such as “Lindrvr”. If the operating system is designed to recognize a predetermined naming system, the actual name of the driver is arbitrary, and the only requirement is consistency between the naming system employed by a particular operating system and the name of the folder and/or device driver stored on the mass storage medium. If the operating system cannot identify which of the folders or device drivers should be retrieved, the operating system can prompt the user to identify the file and/or path where the driver is located.

Next, the operating system determines its regional setting (step 330). Many operating systems are designed to be used in different languages and different countries. Device drivers may include text or other dialog boxes which are used in operating a specific device. Accordingly, the operating system should determine its regional setting so that the device driver which is selected corresponds to the regional setting of the operating system so that the device driver is consistent with the rest of the operating system. The name of the path and/or file for specific regional drivers has the same considerations to those discussed above with regard to operating systems, and hence, the same solutions described above can be employed for the naming system of the path and/or file for regional specific drivers. If a device driver corresponding to the regional setting of the operating system is not found on the mass storage medium (“NO” path out of decision step 340), then a default device driver, e.g., an English version, for the identified operating system is retrieved (step 350). If a device driver corresponding to the regional setting of the operating system is found on the mass storage medium (“YES” path out of decision step 340), then the regional specific device driver for the identified operating system is retrieved. (Step 360). After step 350 or 360, the retrieved device driver is installed by the operating system (step 235) and use of the hardware device is allowed (step 240).

It may occur that a hardware manufacturer designs a number of revisions of the device driver. For example, the initial device driver may not work properly with the operating system, or may not allow use of all of the functionality of the hardware device. To address this problem, the mass storage medium can contain an internet address, such as an IP address or a Uniform Resource Locator (URL), identifying a location where the most current device driver for the hardware device is located. Accordingly, the operating system can either automatically check to determine whether the device driver stored on the mass storage medium is the most recent version, or the operating system can prompt the user to make such a determination.

Many operating system can automatically recognize a mass storage medium which has been attached to the computer. In these operating systems the mass storage medium will appear as a conventional drive, and can be accessed by a user within the operating system environment, e.g., the desktop, or within programs themselves, e.g., in a save dialog box of a program. However, it may be desirable to limit a users access to the mass storage medium, e.g., to prevent the user from deleting the drivers stored therein. User access can be limited in a number of ways, such as having the mass storage medium appear as a locked drive or using a read-only mass storage medium. Some operating system have a default setting which hides operating system files from users. For these operating systems, the files stored on the mass storage medium can be set as operating system files, thereby only allowing users who have disabled this function in the operating system from even noticing the presence of the device drivers.

The invention has been described with reference to a particular embodiment. However, it will be readily apparent to those skilled in the art that it is possible to embody the invention in specific forms other than those of the preferred embodiment described above. This may be done without departing from the spirit of the invention.

Thus, the preferred embodiments are merely illustrative and should not be considered restrictive in anyway. The scope of the invention is given by the appended claims, rather than the preceding description, and all variations and equivalents which fall within the range of the claims are intended to be embraced therein.

1. A method for installing a hardware device on a computer, comprising the steps of:
detecting that a hardware device is connected to the computer for which a driver has not been installed by an operating system of the computer;
locating a mass storage medium on the hardware device;
retrieving a driver for said device from the mass storage medium; and
installing the retrieved driver by the operating system.

2. The method of claim 1, wherein said mass storage medium stores a plurality of drivers associated with different respective operating systems, and further including the step of selecting one of said drivers that is associated with the operating system of the computer for retrieval from said mass storage medium.

3. The method of claim 1, wherein the retrieving step comprises:
identifying a location of driver for a particular operating system;
determining regional setting of an operating system;
determining whether a driver corresponding to the regional setting is found in the identified location; and
retrieving a regional specific driver if one is found in the identified location, and otherwise retrieving a generic driver from the identified location.

4. The method of claim 1 wherein said computer automatically retrieves and installs said driver without user input.

5. The method of claim 1, wherein said computer, upon detecting said hardware device, displays a message that enables a user to select whether the driver is to be retrieved from said mass storage medium or from a different source.

6. The method of claim 1, wherein said hardware device is an image output device.

7. The method of claim 6, wherein said image output device is a printer.

8. The method of claim 1, wherein said hardware device is an image input device.

9. The method of claim 8, wherein said image input device is a scanner.

10. The method of claim 8, wherein said image input device is a camera.

11. A hardware device for a computer, said device comprising:
a functional unit that performs a data input and/or output operation for the computer;
a mass storage medium; and
a driver stored in said mass storage medium that enables the computer to communicate with said functional unit.

12. The hardware device of claim 11, wherein said mass storage medium stores a plurality of drivers associated with different respective operating systems.

13. The hardware device of claim 11, wherein the plurality of drivers comprise regional specific drivers for at least one of the different respective operating systems.

14. The hardware device of claim 11, wherein said functional unit is a printer engine.

15. The hardware device of claim 11, wherein said functional unit is an image capture device.

16. The hardware device of claim 15 wherein said image capture device is a scanner.

17. A computer operating system comprising:
means for detecting a device connected to a computer on which said operating system is executing;
means for determining whether a driver for said device has been installed by the operating system of the computer;
means for detecting whether a driver for said device is stored in a mass storage medium on said device if a driver is determined not to have been installed by the operating system; and
means for retrieving a driver from said mass storage medium and installing the retrieved driver by the operating system.

18. The operating system of claim 17, wherein said driver is automatically retrieved and installed without user input.

19. The operating system of claim 17, further including means for displaying a message that enables a user to select whether the driver is to be retrieved from said mass storage medium or from a different source.
